(19) United States
(12) Patent Application Publication
(10) Pub. No.: US 2005/0111318 A1
(43) Pub. Date: May 26, 2005

(54) Optical disc apparatus, clock signal generation method, program, and control apparatus

(76) Inventors: Takeshi Nakajima, Nara (JP); Harumitsu Miyashita, Nara (JP); Naohiro Kimura, Kyoto (JP)

Correspondence Address: MARK D. SARALINO (GENERAL);RENNER, OTTO, BOISELLE & SKLAR, LLP, 1621 EUCLID AVENUE, NINETEENTH FLOOR, CLEVELAND, OH, 44115-2191, US

(21) Appl. No.: 10/973,780

(22) Filed: Oct. 26, 2004

(30) Foreign Application Priority Data
Oct. 27, 2003 (JP) 2003-365653

(51) Int. Cl. G11B 5/09

(52) U.S. Cl. 369/47.27; 369/47.28

(57) ABSTRACT

An optical disc apparatus is provided, which comprises a signal detection section for detecting a wobble signal from a reproduced signal of an optical disc, and a generation section for generating a clock signal in synchronization with the wobble signal. The generation section comprises a first difference signal generation section for generating a first difference signal indicating a difference between a frequency of the wobble signal and a frequency of the clock signal, a period detection section for detecting a modulation period of the wobble signal based on the first difference signal, and an adjustment section for adjusting the frequency of the clock signal based on a predetermined signal other than the first difference signal during a modulation period, and adjusting the frequency of the clock signal based on the first difference signal during a period other than the modulation period.

This nonprovisional application claims priority under 35 U.S.C. §119(a) on Patent Application No. 2003-365653 filed in Japan on Oct. 27, 2003, the entire contents of which are hereby incorporated by reference.

### BACKGROUND OF THE INVENTION

1. Field of the Invention

The present invention relates to an optical disc apparatus for detecting a wobble signal from a reproduced signal of an optical disc and generating a clock signal in synchronization with a wobble signal. The present invention also relates to a method, program and apparatus for generating a clock signal.

2. Description of the Related Art

Many recordable optical discs have a recording groove for tracking control of an optical head. The recording groove is meandering in predetermined cycles on an optical disc. In this case, the rotational speed of an optical disc can be detected from a reproduced signal of the optical disc. Based on the detected rotational speed, a clock is generated and a motor is controlled.

Japanese Laid-Open Publication No. 2000 100083 discloses a technology relating to an optical disc apparatus which reproduces digital information based on a single frequency of a recording groove formed on an optical disc. A reproduced signal of the optical disc contains a component (wobble signal) caused by the meandering of the recording groove. In the technology, an error between the frequency of the wobble signal and a reproduced clock (referred to as a “channel clock”) is detected so that PLL synchronization is achieved. Further, in the technology, the frequency of a recording clock (referred to as a “wobble clock”) is adjusted so that the wobble clock is synchronized with a wobble signal by PLL.

FIG. 14 shows a conventional wobble clock generation circuit 300 disclosed in Japanese Laid-Open Publication No. 2000 100083.

The wobble clock generation circuit 300 is constructed so that an optical disc 1 is inserted thereinto. The wobble clock generation circuit 300 comprises an optical head 2, a preamplifier 3, a bandpass filter 4, and a binary circuit 5.

The optical head 2 generates light detection signals based on light reflected from the optical disc 1. The preamplifier 3 performs addition and subtraction on the light detection signals to generate a tracking error signal (TE signal) and a radio frequency (RF) signal. For example, when the optical head 2 comprises a two-part split detector (including two detectors), the TE signal indicates a difference between an output of one detector of the two-part split detector and an output of the other detector while the RF signal indicates a sum of the two outputs. The bandpass filter 4 extracts a wobble signal from the TE signal. The binary circuit 5 converts the wobble signal into a binary signal.

The wobble clock generation circuit 300 further comprises a PLL circuit 10. The PLL circuit 10 comprises a phase/frequency comparator 6, a lowpass filter (LPF) 7, a voltage controlled oscillator (VCO) 8, and a frequency divider 9.

The phase/frequency comparator 6 detects a phase difference between the binary signal and a clock signal output by the frequency divider 9. The LPF 7 limits a phase error signal indicating the detected phase difference to a required band, and controls the oscillation frequency of the VCO 8. The VCO 8 generates a clock having a frequency N times that of the wobble clock (N-fold wobble clock). The frequency divider 9 divides the N-fold wobble clock into N, thereby generating a clock signal.

As described with reference to FIG. 14, the PLL circuit 10 generates a clock signal in synchronization with a wobble signal having a single frequency.

Japanese Patent No. 3323824 (particularly, FIGS. 11 and 14) discloses the technique of generating a clock signal from a reproduced signal of an optical disc in more detail. This document describes details of a circuit for effectively generating a clock using a multi-valued delta-sigma modulator, assuming that a signal is reproduced before a disc motor reaches a predetermined rpm or that a signal is reproduced with a CAV (Constant Angular Velocity) from a medium in which a signal has been recorded with a CLV (Constant Linear Velocity).

As a commonly used technique, address information is recorded onto an optical disc by modulating a wobble signal having a constant frequency. In this case, no pit formation is required for recording address information onto an optical disc, resulting in a high level of format efficiency. Modulation of a wobble signal includes, for example, frequency modulation and phase modulation.

Japanese Laid-Open Publication No. 10 69646 (particularly, FIG. 1) discloses a technique of recording address information onto an optical disc by modulating the phase of a wobble signal having a constant frequency. Jung Bae Park, et al., “A New Address Decoder using Digital MSK Demodulation Technique for the HD DVD System”, Technical Digest of ISOM/ODS2002, 2002, p. 114 116, discloses a technique of recording address information onto an optical disc by subjecting a wobble signal having a constant frequency to MSK (Minimum Shift Keying) modulation. On the optical disc, a wobble signal containing a frequency component 1.5 times the constant frequency is recorded. The address information is reproduced by detecting modulation.

Japanese Laid-Open Publication No. 10 154332 (particularly, FIG. 1) discloses a technique of adding a prepit signal component to a wobble signal by forming a prepit having a high reflectance in synchronization with a continuous groove on an optical disc.

As described with reference to FIG. 14, the phase/frequency comparator 6 compares phases between the outputs of the binary circuit 5 and the frequency divider 9, and outputs a signal indicating a frequency error and a signal indicating a phase error. When address information is recorded on an optical disc by modulating the phase or frequency of a wobble signal having a constant frequency, a reproduced wobble signal contains a frequency component in addition to the constant frequency component. Therefore, a frequency error or a phase error cannot be accurately detected based on the reproduced wobble signal. As a result, the jitter of a reproduced clock signal is deteriorated. When the reproduced clock signal is used as a recording clock, the accuracy of mark positions formed on an optical disc is deteriorated.

The deterioration of the jitter of a reproduced clock signal may be avoided by providing a bandpass filter, which has steep pass characteristics, in the wobble clock generation circuit 300. This is because the bandpass filter having steep pass characteristics passes only a clock signal having a single frequency. However, the wobble clock generation circuit 300 comprises the bandpass filter for address detection, resulting in an increase in the scale of the wobble clock generation circuit 300.

The deterioration of the jitter of a reproduced clock signal may also be avoided by lowering the pass band of the LPF 7. In this case, however, the response speed of the wobble clock generation circuit 300 is slow, so that the wobble clock generation circuit 300 has poor access performance.

### SUMMARY OF THE INVENTION

According to an aspect of the present invention, an optical disc apparatus is provided, which comprises a signal detection section for detecting a wobble signal from a reproduced signal of an optical disc, and a generation section for generating a clock signal in synchronization with the wobble signal. The generation section comprises a first difference signal generation section for generating a first difference signal indicating a difference between a frequency of the wobble signal and a frequency of the clock signal, a period detection section for detecting a modulation period of the wobble signal based on the first difference signal, and an adjustment section for adjusting the frequency of the clock signal based on a predetermined signal other than the first difference signal during a modulation period, and adjusting the frequency of the clock signal based on the first difference signal during a period other than the modulation period.

In one embodiment of this invention, the adjustment section adjusts the frequency of the clock signal so that a value of the first difference signal is minimized during the period other than the modulation period.

In one embodiment of this invention, the generation section comprises a determination section for determining whether or not a value of the first difference signal is larger than a predetermined value, and a second difference signal generation section for generating a second difference signal indicating a difference between a phase of the wobble signal and a phase of the clock signal. During the period other than the modulation period, the adjustment section adjusts the frequency of the clock signal based on a determination result of the determination section so that the value of the first difference signal is minimized or a value of the second difference signal is minimized.

In one embodiment of this invention, address information is represented by phase modulation of the wobble signal on the optical disc. The period detection section detects a phase modulation period of the wobble signal based on the first difference signal.

In one embodiment of this invention, address information is represented by minimum shift keying modulation of the wobble signal on the optical disc. The period detection section detects a minimum shift keying modulation period of the wobble signal based on the first difference signal.

In one embodiment of this invention, the generation section comprises an analog-digital converter for sampling the wobble signal with a clock having a frequency N times that of the clock signal, a bandpass filter for extracting the clock signal from an output signal of the analog-digital converter, a rate converter for converting a data rate of an output signal of the bandpass filter to 2M/N of a data rate of the clock signal, where M is an integer of 1 or more, M represents a wobble clock cycle, and N represents a channel clock cycle, a phase comparator for generating a phase difference signal indicating a difference between a phase of the clock signal and a phase of the wobble signal based on an output signal of the rate converter, a phase control loop filter for removing a predetermined signal band component from the phase difference signal, a phase control digital-analog converter for converting an output signal of the phase control loop filter to an analog signal, a frequency control loop filter for removing a predetermined signal band component from the first difference signal output from the first difference signal generation section, a frequency control digital-analog converter for converting an output signal of the frequency control loop filter to an analog signal, an oscillation frequency controller for adding an output signal of the phase control digital-analog converter with an output signal of the frequency control digital-analog converter to generate a control signal, a voltage controlled oscillator for generating a clock having a frequency N times that of the clock signal based on the control signal, and a delta-sigma modulator for controlling the output signal of the phase control loop filter so that a value of the output signal of the phase control loop filter is within a predetermined range, by modulating the output signal of the frequency control loop filter during a predetermined section to change an oscillation frequency of the voltage controlled oscillator, when the value of the output signal of the phase control loop filter is outside the predetermined range.

According to another aspect of the present invention, a method is provided for generating a clock signal, which comprises detecting a wobble signal from a reproduced signal of an optical disc, and generating a clock signal in synchronization with the wobble signal. The generation step comprises generating a first difference signal indicating a difference between a frequency of the wobble signal and a frequency of the clock signal, detecting a modulation period of the wobble signal based on the first difference signal, and adjusting the frequency of the clock signal based on a predetermined signal other than the first difference signal during a modulation period, and adjusting the frequency of the clock signal based on the first difference signal during a period other than the modulation period.

According to another aspect of the present invention, a program is provided for causing a computer to execute a clock signal generation process. The clock signal generation process comprises detecting a wobble signal from a reproduced signal of an optical disc, and generating a clock signal in synchronization with the wobble signal. The generation step comprises generating a first difference signal indicating a difference between a frequency of the wobble signal and a frequency of the clock signal, detecting a modulation period of the wobble signal based on the first difference signal, and adjusting the frequency of the clock signal based on a predetermined signal other than the first difference signal during a modulation period, and adjusting the frequency of the clock signal based on the first difference signal during a period other than the modulation period.

According to another aspect of the present invention, a control apparatus is provided for generating a clock signal in synchronization with a wobble signal contained in a reproduced signal of an optical disc. The apparatus comprises a first difference signal generation section for generating a first difference signal indicating a difference between a frequency of the wobble signal and a frequency of the clock signal, a period detection section for detecting a modulation period of the wobble signal based on the first difference signal, and an adjustment section for adjusting the frequency of the clock signal based on a predetermined signal other than the first difference signal during a modulation period, and adjusting the frequency of the clock signal based on the first difference signal during a period other than the modulation period.

According to the optical disc apparatus, the clock signal generation method, the program, and the control apparatus of the present invention, the frequency of a clock signal is adjusted based on a predetermined signal other than the first difference signal during a modulation period of a wobble signal. Thus, during the modulation period of a wobble signal, the frequency of a clock signal can be adjusted, not based on the first difference signal which is erroneously detected due to modulation of the wobble signal. Therefore, a clock signal having a stable frequency can be generated during the modulation period as well as a period other than the modulation period.

According to the present invention, when address information is recorded on an optical disc by MSK modulation or phase modulation of a wobble signal having a constant frequency, a stable clock signal can be generated in the following manner: when a difference signal indicating a difference between a frequency of a wobble signal and a frequency of a clock signal is generated in order to generate a clock signal in synchronization with the frequency of the wobble signal, based on a reproduced signal of an optical disc, the output of a difference signal erroneously detected due to modulation is held (masked). As a result, when the clock signal is used as a recording clock, an accurate recording mark can be formed on an optical disc. Further, since the output of a difference signal erroneously detected due to modulation is held (masked), the difference signal erroneously detected due to modulation is not input to a control loop. Therefore, a loop gain can be increased, so that access performance is improved. Further, an optical disc apparatus having the same configuration can be used for an optical disc in which a wobble signal having a constant frequency is recorded (e.g., DVD-R, DVD-RAM). As a result, an inexpensive and high-performance optical disc apparatus, which can be used for a number of types of optical discs, can be obtained.

Thus, the invention described herein makes possible the advantages of providing an optical disc apparatus for detecting a wobble signal from a reproduced signal of an optical disc and generating a clock signal in synchronization with a wobble signal; and a method, program and apparatus for generating a clock signal.

These and other advantages of the present invention will become apparent to those skilled in the art upon reading and understanding the following detailed description with reference to the accompanying figures.

### BRIEF DESCRIPTION OF THE DRAWINGS

FIG. 1 shows a wobble signal before and after frequency modulation.

FIG. 2 shows an optical disc apparatus according to Embodiment 1 of the present invention.

FIGS. 3A to 3C show rate-converted wobble signals.

FIG. 4 shows a configuration of a rate converter of FIG. 2.

FIG. 5 shows a configuration of an offset correction section of FIG. 2.

FIG. 6 shows a configuration of a phase control loop filter of FIG. 2.

FIG. 7 shows a configuration of an MSK modulation detector of FIG. 2.

FIG. 8 shows signals (a) to (g) which are processed by a plurality of components contained in an MSK modulation detector of FIG. 2.

FIG. 9 shows a wobble signal before and after phase modulation.

FIG. 10 shows a configuration of an optical disc apparatus according to Embodiment 2 of the present invention.

FIG. 11 shows a configuration of a phase modulation detector according to Embodiment 2 of the present invention.

FIG. 12 shows a configuration of a rate converter according to Embodiment 2 of the present invention.

FIG. 13 is a diagram for explaining an operation of the optical disc apparatus according to Embodiment 2 of the present invention.

FIG. 14 shows a conventional wobble clock generation circuit.

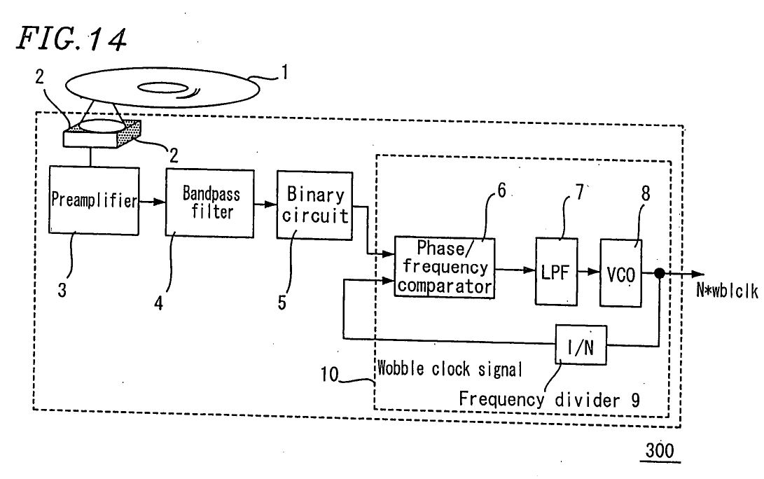

### DESCRIPTION OF THE PREFERRED EMBODIMENTS

Hereinafter, the present invention will be described by way of illustrative examples with reference to the accompanying drawings.

### Embodiment 1

Hereinafter, Embodiment 1 of the present invention will be described, in which a clock signal is generated from a reproduced signal of an optical disc 101. On the optical disc 101, address information is recorded by MSK modulation of a wobble signal having a constant frequency to.

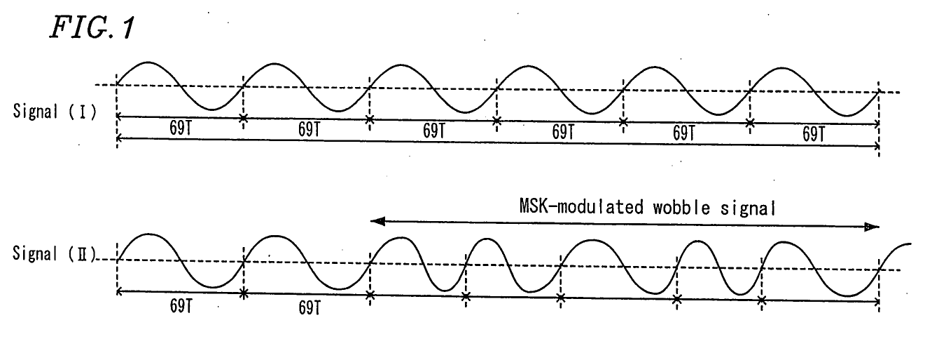

FIG. 1 shows a wobble signal before (I) and after (II) frequency modulation. Specifically, the signal (I) is a wobble signal having a single frequency, which has not been subjected to frequency modulation. One cycle of the signal (I) has 69 channel clock cycles. The signal (II) is a wobble signal which has been subjected to MSK modulation. For example, the frequency of the MSK-modulated wobble signal is 1.5 times the frequency of the wobble signal before frequency modulation.

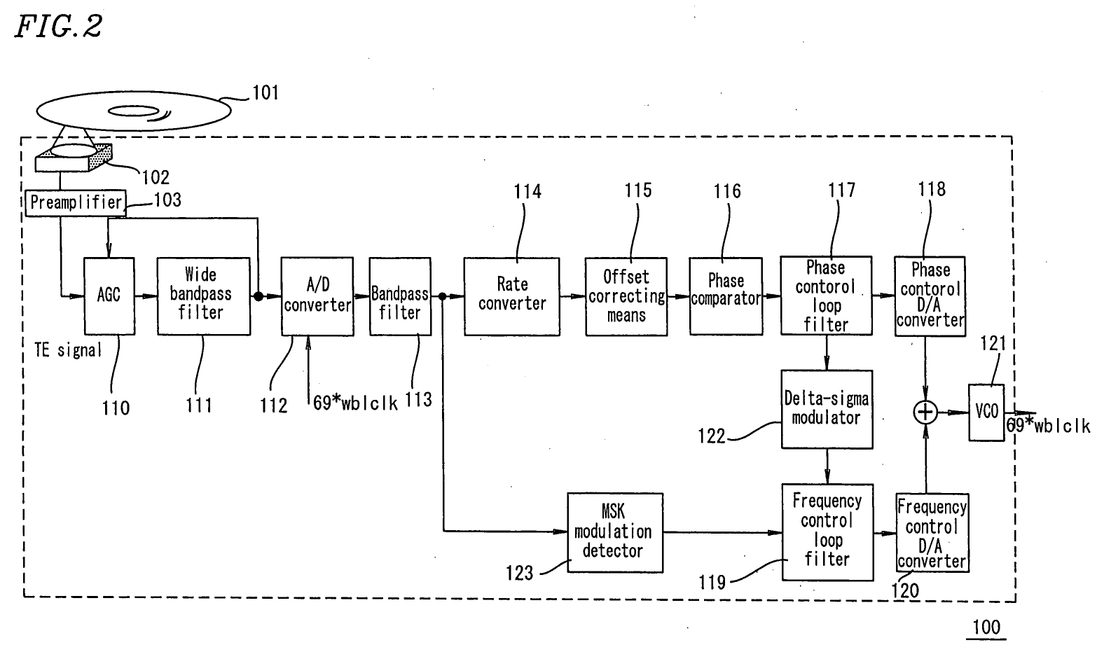

FIG. 2 shows an optical disc apparatus 100 according to Embodiment 1 of the present invention.

The optical disc apparatus 100 is constructed so that the optical disc 100 can be inserted thereinto. The optical disc apparatus 100 comprises an optical head 102, a preamplifier 103, an AGC (Automatic Gain Controller) 110, a wide bandpass filter 111, an A/D converter 112, a bandpass filter 113, and a VCO 121.

The optical head 102 generates light detection signals based on light reflected from the optical disc 101. The optical head 102 comprises a two-part split detector (including two detectors). The preamplifier 3 generates a TE signal based on a difference between an output of one detector of the two-part split detector and an output of the other detector. The TE signal is input to the AGC 110. The AGC 110 performs a feedback control of the wide bandpass filter 111 to cause the amplitude of an output signal of the wide bandpass filter 111 to be constant. The wide bandpass filter 111 has lowpass filter characteristics for passing an address-modulated wobble signal and preventing aliasing. An output of the wide bandpass filter 111 is input to the A/D converter 112. The A/D converter 112 samples the output of the wide bandpass filter 111 with the oscillation frequency (a clock having a frequency 69 times that of a wobble clock (hereinafter referred to as a 69-fold wobble clock)) of the VCO 121 to generate a wobble signal. The bandpass filter 113 filters the wobble signal to output signal components required for detection of an MSK modulation period and generation of a clock signal. A function of the VCO 121 will be described in detail elsewhere below.

The optical disc apparatus 100 further comprises a rate converter 114, an offset correction section 115, a phase comparator 116, a phase control loop filter 117, and a phase control D/A converter 118.

The bandpass filter 113 outputs a signal, which contains a signal component required for generation of a clock signal, to the rate converter 114. The rate converter 114 converts the rate of the signal to 2/N(N=69). An output signal of the rate converter 114 is input to the offset correction section 115. The offset correction section 115 removes a DC component from the output signal of the rate converter 114. The phase comparator 116 detects a phase error signal, which indicates a phase error, based on an output signal of the offset correction section 115. The phase comparator 116 outputs the detected phase error signal to the phase control loop filter 117. The phase control D/A converter 118 converts an output signal of the phase control loop filter 117 into an analog signal.

Details of the rate converter 114, the offset correction section 115, the phase comparator 116, and the phase control loop filter 117 will be described elsewhere below.

Hereinafter, comparison of the frequency of a wobble signal will be described below.

The optical disc apparatus 100 further comprises an MSK modulation detector 123, a frequency control loop filter 119, a frequency control D/A converter 120, and a delta-sigma modulator 122.

An output signal of the bandpass filter 113 is input to the MSK modulation detector 123. The MSK modulation detector 123 detects an MSK-modulated portion of a wobble signal. After detection of the MSK-modulated portion, the MSK modulation detector 123 outputs 0 as a frequency error signal, and holds the control. Details of the MSK modulation detector 123 will be described elsewhere below.

The frequency error signal output from the MSK modulation detector 123 is input to the frequency control loop filter 119. An output of the frequency control loop filter 119 can be represented by βΣyₙ, where yₙ represents a frequency error indicated by the frequency error signal (n is an integer) and β represents a positive constant which determines frequency control characteristics.

An output signal of the frequency control loop filter 119 is input to the frequency control D/A converter 120. An output signal of the frequency control D/A converter 120 is added with an output signal of the phase control D/A converter 118.

The output signal of the phase control loop filter 117 is also input to the delta-sigma modulator 122. When the output signal of the phase control loop filter 117 exceeds a predetermined range, the delta-sigma modulator 122 controls the frequency control loop filter 119 so that the output signal of the frequency control loop filter 119 to the frequency control D/A converter 120 is changed by 1 LSB. The frequency of an output signal of the frequency control D/A converter 120 is significantly changed per LSB. Therefore, the oscillation frequency of the VCO 121 is steeply changed, so that the control loop is unlikely to follow the oscillation frequency of the VCO 121. Therefore, delta-sigma modulation is used to subject the output signal of the frequency control loop filter 119 to pulse-width modulation during a predetermined period of time. As a result, the control loop can follow the frequency. Therefore, for example, even when an optical disc recorded with a CLV is reproduced with a CAV, a clock can be consistently generated in synchronization with a wobble signal.

As described above, the phase control loop filter 117, the frequency control loop filter 119, the frequency control D/A converter 120, and the delta-sigma modulator 122 cooperate to adjust the frequency of the clock signal based on a predetermined signal (e.g., a 0 signal, a hold signal) other than the frequency error signal during a modulation period of the wobble signal (e.g., a period during when the result of MSK detection is Low) or based on the frequency error signal during a period other than the modulation period of the wobble signal (e.g., a period during which the result of MSK detection is High). Further, the phase control loop filter 117, the frequency control loop filter 119, the frequency control D/A converter 120, and the delta-sigma modulator 122 cooperate to adjust the frequency of the clock signal so that the frequency error signal is minimized, during a period other than the modulation period of the wobble signal.

In general, a D/A converter has a limited range. Therefore, the frequency control D/A converter 120 performs a rough control, while the phase control D/A converter 118 performs a fine control.

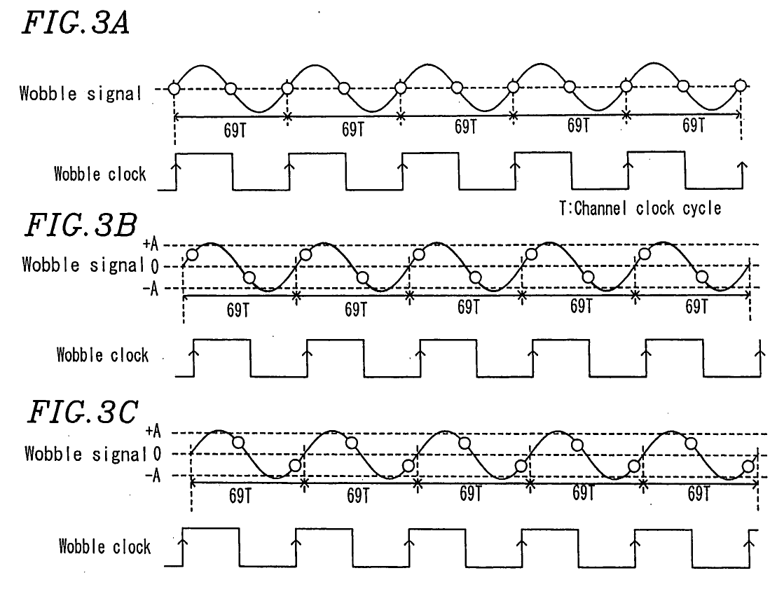

FIGS. 3A to 3C show rate-converted wobble signals. FIG. 3A shows a wobble signal whose phase is substantially equal to the phase of a clock signal. FIG. 3B shows a wobble signal whose phase is advanced from the phase of a clock signal. FIG. 3C shows a wobble signal whose phase is delayed from the phase of a clock signal.

In FIGS. 3A to 3C, a wobble signal having a value indicated by an open circle is output at the rising and falling of a clock signal.

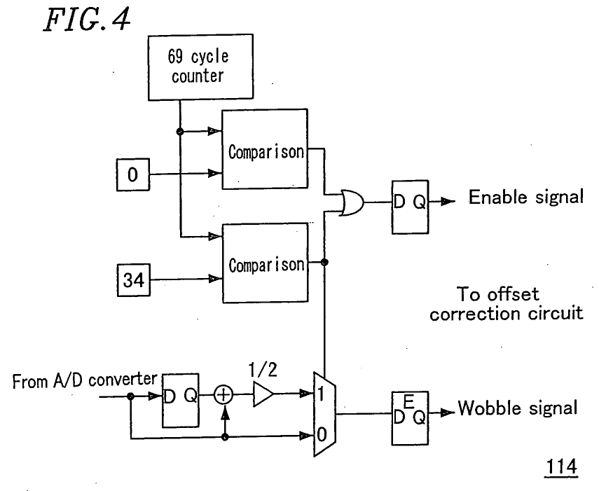

FIG. 4 shows a configuration of the rate converter 114. Referring to FIG. 4, the rate converter 114 will be described.

The rate converter 114 operates a 69 cycle counter with a 69-fold wobble clock. When the count value is ‘0’ and ‘34’, the rate converter 114 outputs an enable signal. When the count value is ‘0’, the rate converter 114 outputs a signal received from the A/D converter 112. When the count value is ‘34’, the rate converter 114 outputs a signal obtained by adding a signal received from the A/D converter 112 to a signal obtained by delaying the signal received from the A/D converter 112 by 1 clock cycle, and multiplying the resultant signal by ½. In other words, the rate converter 114 extracts an interpolation signal from a signal obtained by sampling a wobble signal with the 69-fold wobble clock. An output of the rate converter 114 is input to the offset correction section 115.

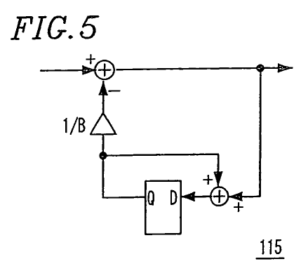

FIG. 5 shows a configuration of the offset correction section 115. The offset correction section 115 will be described with reference to FIGS. 3 and 5.

The offset correction section 115 comprises an adder, a subtractor, and a flip-flop circuit. The offset correction section 115 detects a DC component of a signal obtained by sampling a wobble signal with a wobble clock signal (indicated with open circles), and causes the DC component to be 0 (see FIG. 3A). The offset correction section 115 performs a feedback control using the adder, the subtractor, and the flip-flop circuit. Since input signals have two's complements, the input signals are corrected so that the average of outputs of the offset correction section 115 is 0.

Hereinafter, the phase comparator 116 will be described in detail.

The phase comparator 116 detects a phase error signal indicating a phase error based on a signal output from the offset correction section 115.

A signal sampled at the rising of a wobble clock has a positive value, while a signal sampled at the falling of a wobble clock has a negative value (see FIG. 3B). A phase error can be obtained by multiplying an input signal with a cosine wave (COS(nπ), n is an integer: n is positive at the rising of a wobble clock, while n is negative at the falling of a wobble clock). When the phase of a wobble clock is delayed, a positive phase error is output so as to increase the oscillation frequency (see FIG. 3B). Similarly, when the phase of a wobble clock is advanced, a negative phase error is output so as to decrease the oscillation frequency (see FIG. 3C).

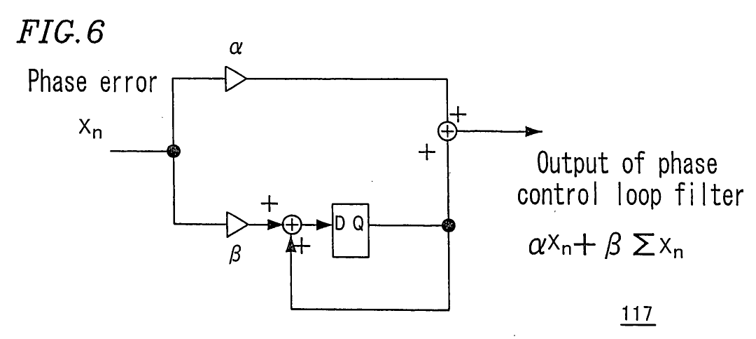

FIG. 6 shows a configuration of the phase control loop filter 117.

An output of the phase control loop filter 117 can be represented by αxₙ+βΣxₙ, where xₙ (n is an integer) represents a phase error input to the phase control loop filter 117, and α and β are positive constants which determine phase control characteristics.

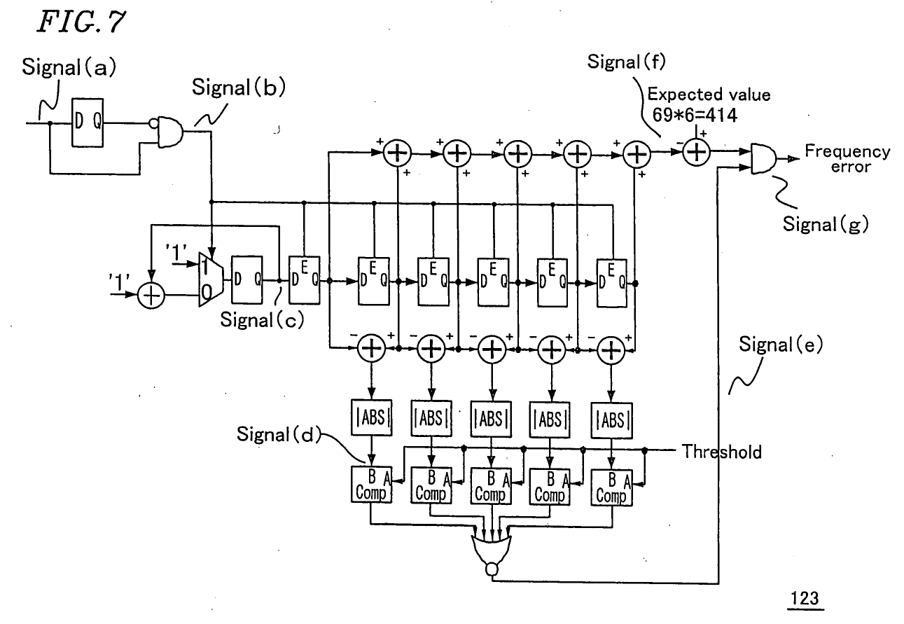

FIG. 7 shows a configuration of the MSK modulation detector 123.

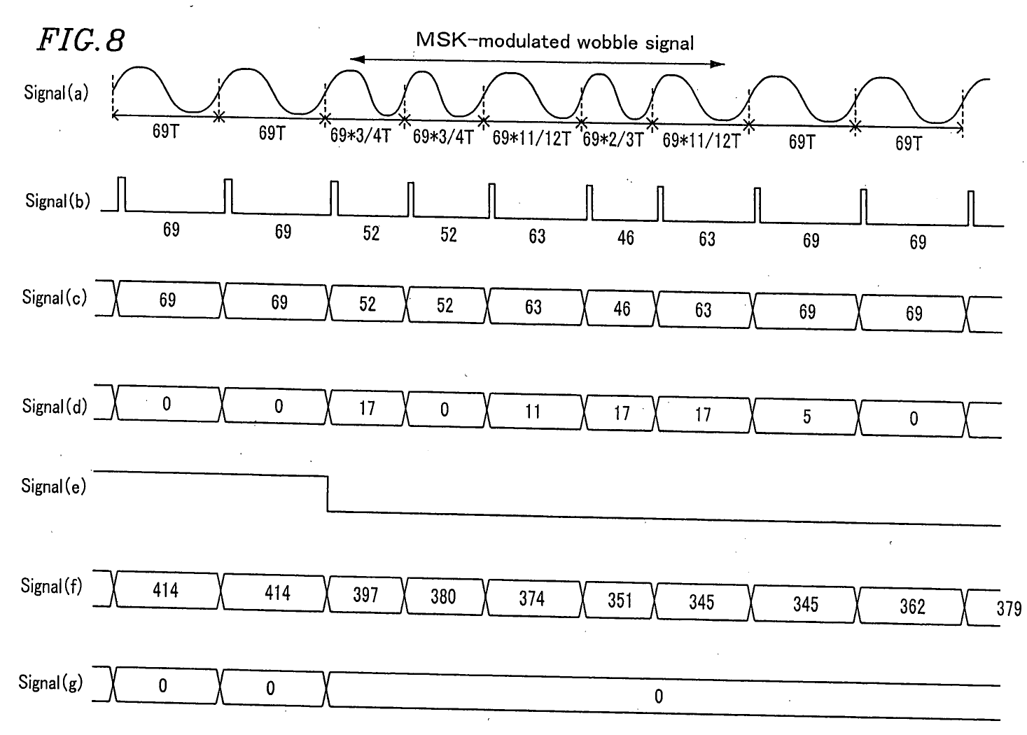

FIG. 8 shows signals (a) to (g) which are processed by a plurality of components contained in the MSK modulation detector 123.

The MSK modulation detector 123 generates a frequency error (first difference signal) indicating a frequency difference between a wobble signal and a clock signal. Further, the MSK modulation detector 123 detects a modulation period of the wobble signal based on the frequency error.

Hereinafter, a function of the MSK modulation detector 123 will be described in detail with reference to FIGS. 7 and 8.

When an output of the bandpass filter 113 is larger than 0, a signal having a value of 0 is input to the MSK modulation detector 123. When an output of the bandpass filter 113 is smaller than 0, a signal having a value of 1 is input to the MSK modulation detector 123. Only the sign bit of the bandpass filter 113 is input to the MSK modulation detector 123.

When the MSK-modulated wobble signal (signal (a)) is input to the MSK modulation detector 123, the MSK modulation detector 123 detects only the rising edge of a wobble signal and outputs an edge pulse (signal (b)).

An interval between edge pulses is measured, so that a result of addition is obtained (signal (c)). When a wobble signal has an ideal single frequency, the addition result has a value of 69. However, when the wobble signal has a MSK-modulated frequency, the addition result is no more than 69. This is because the frequency of the MSK-modulated wobble signal is 1.5 times the single frequency of the wobble signal before MSK modulation.

The addition result is stored into six registers which are enabled for each edge pulse. A difference between each register is obtained. When at least one of the absolute values of the differences is larger than a predetermined value, it is determined that the wobble signal contains an MSK modulation component (signal (e)). A result of addition of the six registers indicates a time corresponding to six cycles of the wobble signal (signal (f)). When the wobble signal is an ideal single-frequency signal, the time corresponding to six cycles of the wobble signal is 414 channel clock cycles, a difference between the expected 414 channel clock cycles and the addition result is a frequency error. When the result of MSK detection (signal (e)) is High, the MSK modulation detector 123 outputs the detected frequency error. When the result of MSK detection is Low, the MSK modulation detector 123 outputs 0 as the frequency error. By detecting an MSK modulation component contained in a wobble signal, a frequency error can be removed.

The number of registers contained in the MSK modulation detector 123 is not limited to six. Any number of registers may be contained in the MSK modulation detector 123. For example, when the MSK modulation detector 123 has three registers, a time corresponding to three cycles of a wobble signal is 207 channel clock cycles, assuming that the wobble signal is an ideal single-frequency signal. In this case, therefore, a difference between the expected 207 channel clock cycles and the addition result is a frequency error.

Further, the number of registers may be changed between six and three. The addition result of the three registers indicates the time corresponding to three cycles of a wobble signal, while the addition result of the six registers indicates the time corresponding to six cycles of a wobble signal. The larger number of registers advantageously provides a higher level of detection precision of the MSK modulation detector 123, but disadvantageously provides a lower response speed of the MSK modulation detector 123. When the user can change the number of registers, the user can determine the number of registers depending on the quality of a reproduced signal of the optical disc 101 while taking into account the merits and demerits of the number of registers. For example, when the quality of a reproduced signal of the optical disc 101 is good, the user places importance on the response speed of the MSK modulation detector 123. In this case, therefore, the number of registers is set to three so as to measure the time corresponding to three cycles of a wobble signal. When the quality of a reproduced signal of the optical disc 101 is poor, the user places importance on the detection precision of the MSK modulation detector 123. The number of registers is changed to six so as to measure the time corresponding to six cycles of a wobble signal. The number of registers may be changed by the user externally inputting a switching signal to the optical disc apparatus 100.

### Embodiment 2

Hereinafter, Embodiment 2 of the present invention will be described, in which a clock signal is generated from a reproduced signal of an optical disc 201. On the optical disc 201, address information is recorded by phase modulation of a wobble signal having a constant frequency to.

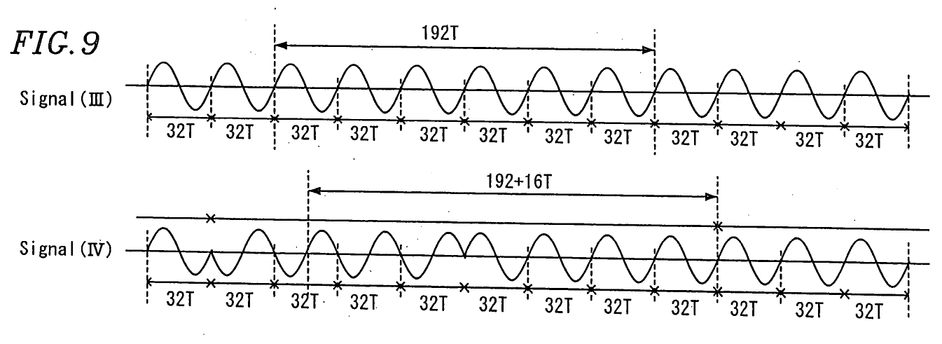

FIG. 9 shows a wobble signal before (III) and after (IV) phase modulation. Specifically, the signal (III) is a single signal having a cycle 32 times a channel clock cycle. The signal (IV) is a wobble signal whose phase is reversed at two points thereof.

The length corresponding to six cycles of a wobble signal is compared between the signal (III) and the signal (IV). The length corresponding to six cycles of the single signal (III) is 192 channel clock cycles. The length corresponding to six cycles of the wobble signal (IV) having two phase reversals is 208 channel clock cycles. This is because the interval of the rising edge is 48 channel clock cycles in a section in which the phase is reversed.

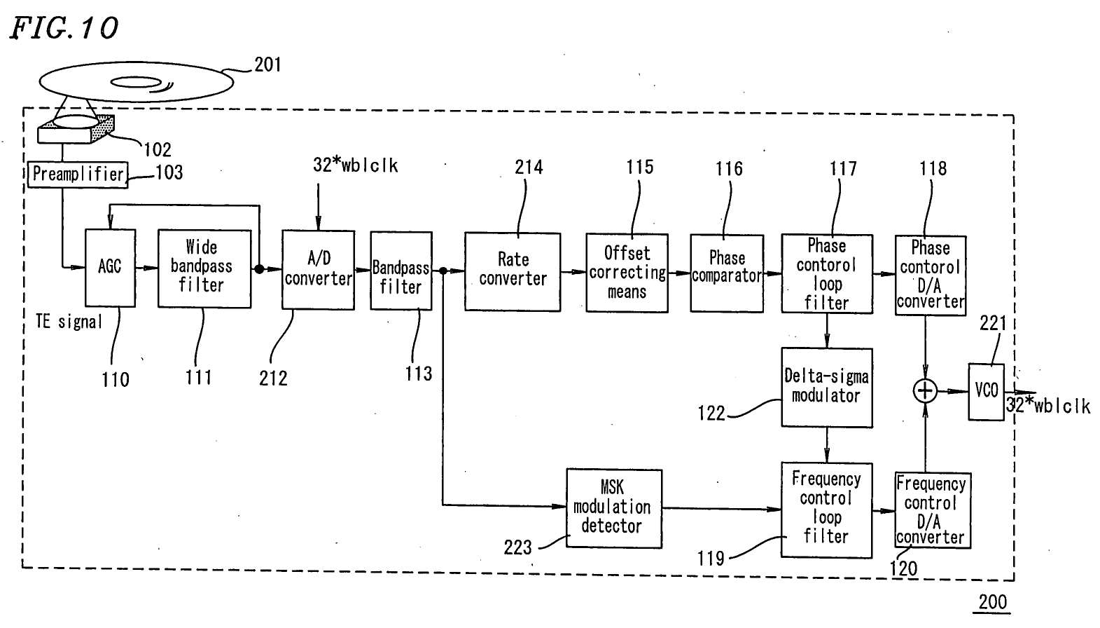

FIG. 10 shows a configuration of an optical disc apparatus 200 according to Embodiment 2 of the present invention.

The optical disc apparatus 200 is constructed so that the optical disc 201 can be inserted thereinto. On the optical disc 201, address information is recorded by phase modulation of a wobble signal having a constant frequency.

The optical disc apparatus 200 comprises the same components as those of the optical disc apparatus 100, except for an A/D converter 212 in place of the A/D converter 112, a rate converter 214 in place of the rate converter 114, a VCO 221 in place of the VCO 121, and a phase modulation detector 223 in place of the MSK modulation detector 123. In FIG. 10, the same components as those of the optical disc apparatus 100 of FIG. 2 are reference with the same reference numerals, and will not be explained.

The A/D converter 212 samples an output of the wide bandpass filter 111 with the oscillation frequency (a clock having a frequency 32 times that of a wobble clock (hereinafter referred to as a 32-fold wobble clock)) of the VCO 221 to generate a wobble signal. The rate converter 214 converts the rate of the signal to 2/N(N=32).

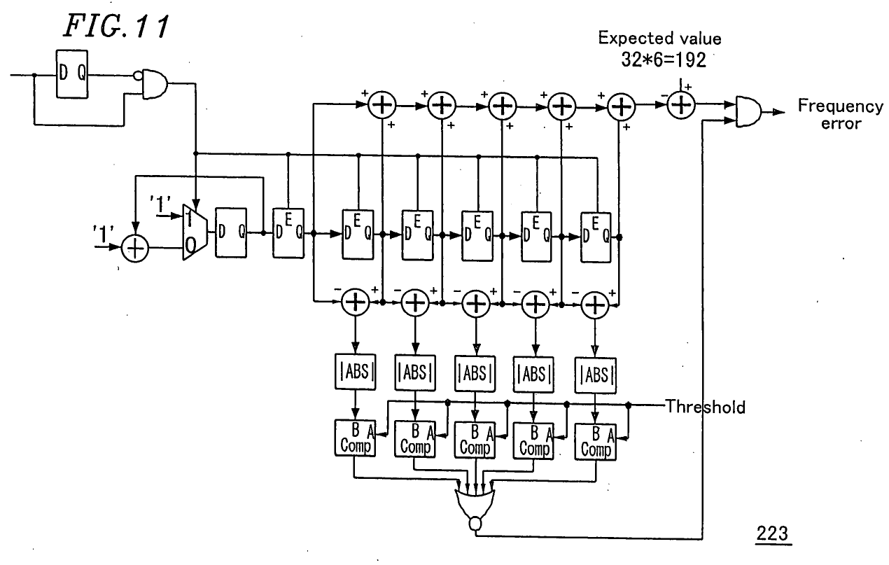

FIG. 11 shows a configuration of the phase modulation detector 223 according to Embodiment 2 of the present invention.

The configuration of the phase modulation detector 223 is the same as that of the MSK modulation detector 123 of Embodiment 1 of the present invention, except for a subtraction circuit. The subtraction circuit of the MSK modulation detector 123 is constructed to detect a difference from 414 channel clock cycles as a frequency error. The subtraction circuit of the phase modulation detector 223 is constructed to detect a difference from 192 channel clock cycles as a frequency error.

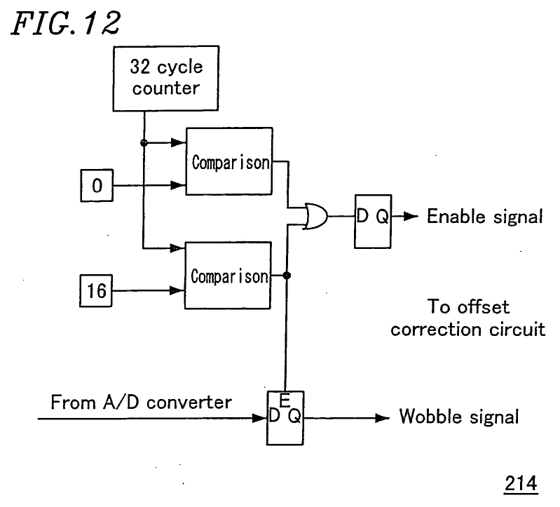

FIG. 12 shows a configuration of the rate converter 214 according to Embodiment 2 of the present invention.

The rate converter 214 operates a 34 cycle counter with a 34-fold wobble clock. When the count value is ‘0’ and ‘16’, the rate converter 214 outputs an enable signal. When the count value is ‘0’ or ‘16’, the rate converter 214 outputs a signal received from the A/D converter 212. Thus, according to the rate converter 214, even when a wobble signal is subjected to phase modulation, a wobble clock can be generated in synchronization with the wobble signal. An output of the rate converter 214 is input to the offset correction section 115.

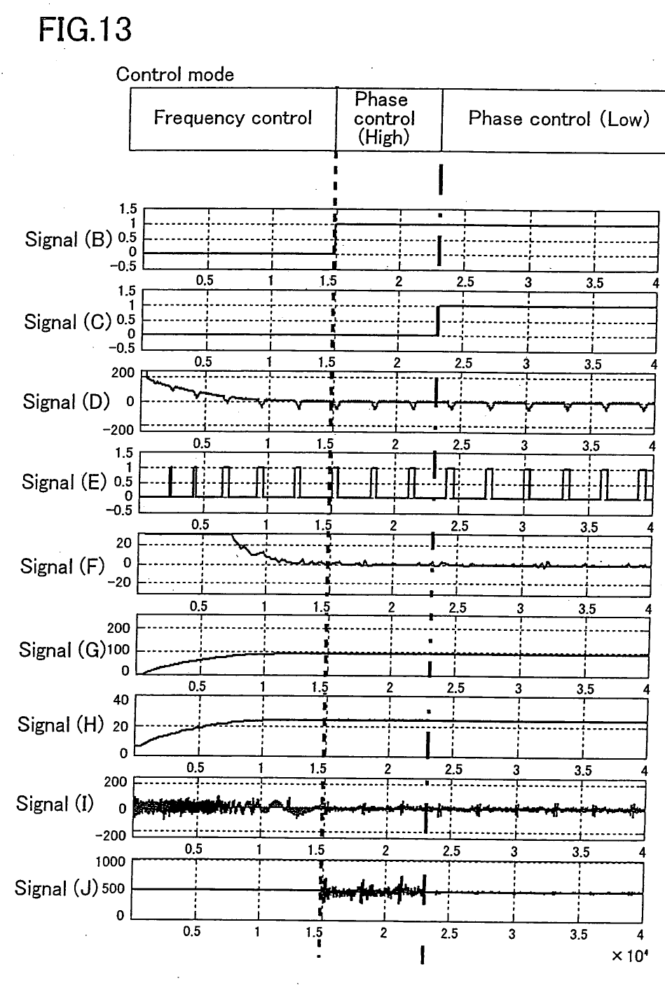

FIG. 13 is a diagram for explaining an operation of the optical disc apparatus 200 according to Embodiment 2 of the present invention.

For example, the optical disc apparatus 200 controls the optical disc 201 with a CAV to perform a seek operation from an inner periphery to an outer periphery of the optical disc 201. In this case, the rotational speed of a spindle motor is constant. Therefore, after an optical head reaches a predetermined position and a focusing control is performed, a tracking control is performed, so that a wobble signal having a high frequency is input.

Immediately after the seek operation, a control signal (signal (B) and signal (C)) is Low and a control mode is a frequency control. A frequency error detected by the phase modulation detector 223 has a large positive value immediately after the seek operation (signal (D)). The positive frequency error causes an output of the frequency control loop filter 119 to be gradually increased (signal (G)). Therefore, the oscillation frequency of the VCO 221 is also increased (signal (H)).

A signal (E) indicates that a phase modulation portion is detected in a wobble signal. The signal (E) is High in a section in which phase modulation is detected. When the frequency error (signal (D)) is output as a frequency error 0 in the phase modulation detection section, a frequency error output (signal (F)) is obtained. It will be understood that the oscillation frequency of the VCO 221 is controlled without decreasing the frequency excessively due to phase modulation. As the oscillation frequency of the VCO 221 approaches an input wobble signal, a phase control is activated while a frequency control is stopped. When the signal (B) is High and the signal (C) is Low, the α and β of the phase control loop filter 117 are set to high values (high gain).

A signal (I) indicates a detected phase error. A signal (J) indicates an output of the phase control loop filter 117. During a frequency control, the phase is initially set to a center of the range. When a phase control is started, a control signal is output.

When the signals (B) and (C) go to High, the α and β of the phase control loop filter 117 are set to low values to reduce the gain of the loop so that the control is performed without an influence due to a certain level of external perturbation. As a result, a stable wobble clock is consistently generated.

Embodiments 1 and 2 of the present invention have been described with reference to FIGS. 1 to 12.

For example, as described with reference to FIG. 2, the A/D converter 112 corresponds to a “signal detection section for detecting a wobble signal from a reproduced signal of an optical disc”. The bandpass filter 113, the rate converter 114, the offset correction section 115, the phase comparator 116, the phase control loop filter 117, the phase control D/A converter 118, the frequency control loop filter 119, the frequency control D/A converter 120, the VCO 121, the delta-sigma modulator 122, and the MSK modulation detector 123 correspond to a “generation section for generating a clock signal in synchronization with a wobble signal”. The MSK modulation detector 123 corresponds to a “first difference signal generation section for generating a first difference signal indicating a difference between a frequency of a wobble signal and a frequency of a clock signal” and a “period detection section for detecting a modulation period of a wobble signal based on the first difference signal”. The frequency control loop filter 119, the frequency control D/A converter 120, and the delta-sigma modulator 122 correspond to an “adjustment section for adjusting a frequency of a clock signal based on a predetermined signal other than the first difference signal during a modulation period, and adjusting the frequency of the clock signal based on the first difference signal during a period other than the modulation period”.

However, the optical disc apparatus of the present invention is not limited to that which is shown in FIG. 2 or 10. An optical disc apparatus having any configuration may fall within the scope of the present invention as long as it achieves the function of each section described above.

Each section described in the embodiments shown in FIGS. 2 and 10 may be implemented as either hardware or software, or in combination thereof. In any of these cases, the optical disc apparatus 100 or 200 may perform a clock signal generation process comprising “detecting a wobble signal from a reproduced signal of an optical disc”, “generating a clock signal in synchronization with a wobble signal”, “generating a first difference signal indicating a difference between a frequency of a wobble signal and a frequency of a clock signal”, “detecting a modulation period of a wobble signal based on the first difference signal”, and “adjusting a frequency of a clock signal based on a predetermined signal other than the first difference signal during a modulation period, and adjusting the frequency of the clock signal based on the first difference signal during a period other than the modulation period”. The clock signal generation process of the present invention may have any procedure as long as it can perform each step described above.

For example, the optical disc apparatus of the present invention stores a clock signal generation process program for executing the function of an optical disc apparatus. The clock signal generation process program executes the function of the optical disc apparatus.

The clock signal generation process program may be stored in a storage section contained in an optical disc apparatus before a computer is shipped. Alternatively, after the computer is shipped, the clock signal generation process program may be stored in the storage section. For example, the clock signal generation process program may be downloaded by the user from a particular web site on the Internet with or without payment, and the downloaded program may be installed into a computer. When the clock signal generation process program is recorded in a computer readable recording medium, such as a flexible disc, a CD-ROM, a DVD -ROM, or the like, an input apparatus (e.g., a disc drive apparatus) may be used to install the clock signal generation process program into a computer. The installed clock signal generation process program is stored in the storage section.

The control apparatus (the bandpass filter 113, the rate converter 114, the offset correction section 115, the phase comparator 116, the phase control loop filter 117, the phase control D/A converter 118, the frequency control loop filter 119, the frequency control D/A converter 120, the VCO 121, the delta-sigma modulator 122, and the MSK modulation detector 123) may be fabricated as the whole or a part of a one-chip LSI (semiconductor integrated circuit). When the control apparatus is fabricated as a one-chip LSI, the fabrication process of the optical disc apparatus 100 or 200 can be simplified.

The optical disc apparatus, the clock signal generation method, the program, and the control apparatus of the present invention have a function of masking a frequency error and are useful for reproduction of a communication carrier wave.

According to the optical disc apparatus, the clock signal generation method, the program, and the control apparatus of the present invention, the frequency of a clock signal is adjusted based on a predetermined signal other than the first difference signal during a modulation period of a wobble signal. Thus, during the modulation period of a wobble signal, the frequency of a clock signal can be adjusted, not based on the first difference signal which is erroneously detected due to modulation of the wobble signal. Therefore, a clock signal having a stable frequency can be generated during the modulation period as well as a period other than the modulation period.

Although certain preferred embodiments have been described herein, it is not intended that such embodiments be construed as limitations on the scope of the invention except as set forth in the appended claims. Various other modifications and equivalents will be apparent to and can be readily made by those skilled in the art, after reading the description herein, without departing from the scope and spirit of this invention. All patents, published patent applications and publications cited herein are incorporated by reference as if set forth fully herein.

1. An optical disc apparatus, comprising:
a signal detection section for detecting a wobble signal from a reproduced signal of an optical disc; and
a generation section for generating a clock signal in synchronization with the wobble signal,
wherein the generation section comprises:
a first difference signal generation section for generating a first difference signal indicating a difference between a frequency of the wobble signal and a frequency of the clock signal;
a period detection section for detecting a modulation period of the wobble signal based on the first difference signal; and
an adjustment section for adjusting the frequency of the clock signal based on a predetermined signal other than the first difference signal during a modulation period, and adjusting the frequency of the clock signal based on the first difference signal during a period other than the modulation period.

2. An optical disc according to claim 1, wherein the adjustment section adjusts the frequency of the clock signal so that a value of the first difference signal is minimized, during the period other than the modulation period.

3. An optical disc according to claim 1, wherein the generation section comprises:
a determination section for determining whether or not a value of the first difference signal is larger than a predetermined value; and
a second difference signal generation section for generating a second difference signal indicating a difference between a phase of the wobble signal and a phase of the clock signal,
wherein during the period other than the modulation period, the adjustment section adjusts the frequency of the clock signal based on a determination result of the determination section so that the value of the first difference signal is minimized or a value of the second difference signal is minimized.

4. An optical disc according to claim 1, wherein address information is represented by phase modulation of the wobble signal on the optical disc, and
the period detection section detects a phase modulation period of the wobble signal based on the first difference signal.

5. An optical disc according to claim 1, wherein
address information is represented by minimum shift keying modulation of the wobble signal on the optical disc, and
the period detection section detects a minimum shift keying modulation period of the wobble signal based on the first difference signal.

6. An optical disc according to claim 1, wherein the generation section comprises:
an analog-digital converter for sampling the wobble signal with a clock having a frequency N times that of the clock signal;
a bandpass filter for extracting the clock signal from an output signal of the analog-digital converter;
a rate converter for converting a data rate of an output signal of the bandpass filter to 2M/N of a data rate of the clock signal, where M is an integer of 1 or more, M represents a wobble clock cycle, and N represents a channel clock cycle;
a phase comparator for generating a phase difference signal indicating a difference between a phase of the clock signal and a phase of the wobble signal based on an output signal of the rate converter;
a phase control loop filter for removing a predetermined signal band component from the phase difference signal;
a phase control digital-analog converter for converting an output signal of the phase control loop filter to an analog signal;
a frequency control loop filter for removing a predetermined signal band component from the first difference signal output from the first difference signal generation section;
a frequency control digital-analog converter for converting an output signal of the frequency control loop filter to an analog signal;
an oscillation frequency controller for adding an output signal of the phase control digital-analog converter with an output signal of the frequency control digital-analog converter to generate a control signal;
a voltage controlled oscillator for generating a clock having a frequency N times that of the clock signal based on the control signal; and
a delta-sigma modulator for controlling the output signal of the phase control loop filter so that a value of the output signal of the phase control loop filter is within a predetermined range, by modulating the output signal of the frequency control loop filter during a predetermined section to change an oscillation frequency of the voltage controlled oscillator, when the value of the output signal of the phase control loop filter is outside the predetermined range.

7. A method for generating a clock signal, comprising:
detecting a wobble signal from a reproduced signal of an optical disc; and
generating a clock signal in synchronization with the wobble signal,
wherein the generation step comprises:
generating a first difference signal indicating a difference between a frequency of the wobble signal and a frequency of the clock signal;
detecting a modulation period of the wobble signal based on the first difference signal; and
adjusting the frequency of the clock signal based on a predetermined signal other than the first difference signal during a modulation period, and adjusting the frequency of the clock signal based on the first difference signal during a period other than the modulation period.

8. A program for causing a computer to execute a clock signal generation process, wherein the clock signal generation process comprises:
detecting a wobble signal from a reproduced signal of an optical disc; and
generating a clock signal in synchronization with the wobble signal,
wherein the generation step comprises:
generating a first difference signal indicating a difference between a frequency of the wobble signal and a frequency of the clock signal;
detecting a modulation period of the wobble signal based on the first difference signal; and
adjusting the frequency of the clock signal based on a predetermined signal other than the first difference signal during a modulation period, and adjusting the frequency of the clock signal based on the first difference signal during a period other than the modulation period.

9. A control apparatus for generating a clock signal in synchronization with a wobble signal contained in a reproduced signal of an optical disc, the apparatus comprising:
a first difference signal generation section for generating a first difference signal indicating a difference between a frequency of the wobble signal and a frequency of the clock signal;
a period detection section for detecting a modulation period of the wobble signal based on the first difference signal; and
an adjustment section for adjusting the frequency of the clock signal based on a predetermined signal other than the first difference signal during a modulation period, and adjusting the frequency of the clock signal based on the first difference signal during a period other than the modulation period.
